(19) United States
(12) Patent Application Publication
(10) Pub. No.: US 2013/0025528 A1
(43) Pub. Date: Jan. 31, 2013

(54) PONTOON BOAT MULTI-SEGMENT WALL STRUCTURE WITH SEAM COVER

(71) Applicant: John R. Cooney, Midland, MI (US)

(72) Inventor: John R. Cooney, Midland, MI (US)

(21) Appl. No.: 13/194,696

(22) Filed: Jul. 29, 2011

(51) Int. Cl. B63B 17/00; B23P 11/00

(52) U.S. Cl. 114/364; 29/428

(57) ABSTRACT

A pontoon boat including a first wall segment and a second wall segment. The first and second wall segments are arranged end-to-end to present a joint therebetween. A joint cover formed as a separate piece from the first and second wall segments bridges across and substantially conceals the joint. A transition feature, such as a decal, is disposed on one of the wall segments adjacent to the cover. The transition feature including a first color zone, a second color zone and a transition zone is disposed on one of the wall segments adjacent the joint cover.

### BACKGROUND OF THE INVENTION

1. Field of the Invention

The invention is directed to pontoon boats, and more particularly to pontoon boats including multiple segment wall structures.

2. Description of the Related Art

Pontoon boats are becoming an increasingly popular choice among boat owners who are looking for a vessel that can accommodate a large family or group of people in a comfortable environment for leisure and/or entertainment purposes. Additional advantages of pontoon boats over other options include their ability to navigate shallow water with ease, their relatively low cost compared to other boat options of comparable size, the ability to configure the deck area with a variety of seating configurations and other options, and their ease of handling to name just a few.

Pontoon boats are typically constructed to include a generally flat platform or deck which is mounted to two or more hollow, tubular floatable pontoons to support the deck off the water. The typical construction further includes some type of barrier or wall system that extends about the perimeter of the deck to define a passenger space and some type of seating arrangement within the passenger space.

The wall system itself typically includes multiple sections of tubular structural framing that is anchored to the decking and often the open areas of the framing are fitted with decorative panels of sheet metal to provide a solid wall appearance as well as a containment barrier for the passengers on board.

### SUMMARY OF THE INVENTION

As the overall market for pontoon boats grows, it is recognized that there is a growing segment of the market looking for a more refined appearance of the wall systems. There are presently limited offerings in the design and appearance of the wall systems for pontoon boats, with most having multiple wall segments with the joints exposed, and many having a single color theme among the panel. The wall system contemplated by of this invention addresses the shortcomings of the prior known wall systems in both function and appearance as described in further detail below.

An aspect of the present invention is to provide a structurally sound wall system for pontoon boats that improves upon the appearance of traditional wall systems. According to a particular feature of this improved wall system, the wall is made up of multiple wall segments each with its own decorative panel. Where adjacent wall segments meet, there is a physical joint. The joint is concealed by provision of a decorative joint cover that bridges across the adjacent panels and overlies the joint. The joint cover is secured to one or both panels by fasteners, adhesives, or the like.

One advantage of a pontoon boat having such a wall system is that it enables the manufacture to pre-construct the individual wall segments of different size, shape, color, features or the like; combine them in any of a number of combinations on the boat decking (e.g., combine adjacent wall sections of two different colors or designs); and then conceal the joint between the adjacent segments to give the appearance of a one-piece wall having different onstructional and/or design attributes. This enables a manufacturer to produce high-end grade wall systems in a cost-efficient manner and provides customers with more custom-order options when placing an order for a new pontoon.

According to another aspect of the invention, a pontoon boat is provided comprising a plurality of pontoons, a deck secured to the pontoons, a plurality of wall segments anchored to and extending upwardly from the deck to provide an interior space of the deck for accommodating passengers, and where the plurality of wall segments include at least a first discrete wall segment having an associated outer panel surface and at least a second discrete wall segment having an associated outer panel surface, and further where the at least first and second wall segments are arranged end-to-end to present a joint therebetween; and including a joint cover formed as a separate piece from that of the at least first and second wall segments panels and bridging across and substantially concealing the joint.

According to a further aspect of the invention, disposed adjacent to the joint cover is an optional transition feature, which is preferably a decal, or any other type of sticker. The transition feature may include a first color zone, a second color zone, and a transition zone extending between the first and second color zones. The transition zone may progressively change from the first color to the second color. The unique combination of the cover and the transition feature presents a particularly appealing bridge between the two different wall segments that may be, for example, of different colors. In this way, wall segments having different colors, for example, can be placed adjacent to one another to present a unique appearance without the undesirable consequences of having a visible seam separating two different colors. This gives the pontoon boat a unique, luxurious external appearance which is believed to be previously unattainable with conventional wall systems of pontoon boats.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a perspective and elevation view of a first exemplary embodiment of the pontoon boat;

FIG. 2 is a front view of two exemplary wall segments disposed adjacent to one another without the cover or the transition feature;

FIG. 3 is a front view of the same two exemplary wall segments disposed adjacent to one another with the cover and the transition feature; and

FIG. 4 is an enlarged fragmentary cross sectional view taken along lines 4-4 of FIG. 3.

### DETAILED DESCRIPTION OF THE ENABLING EMBODIMENTS

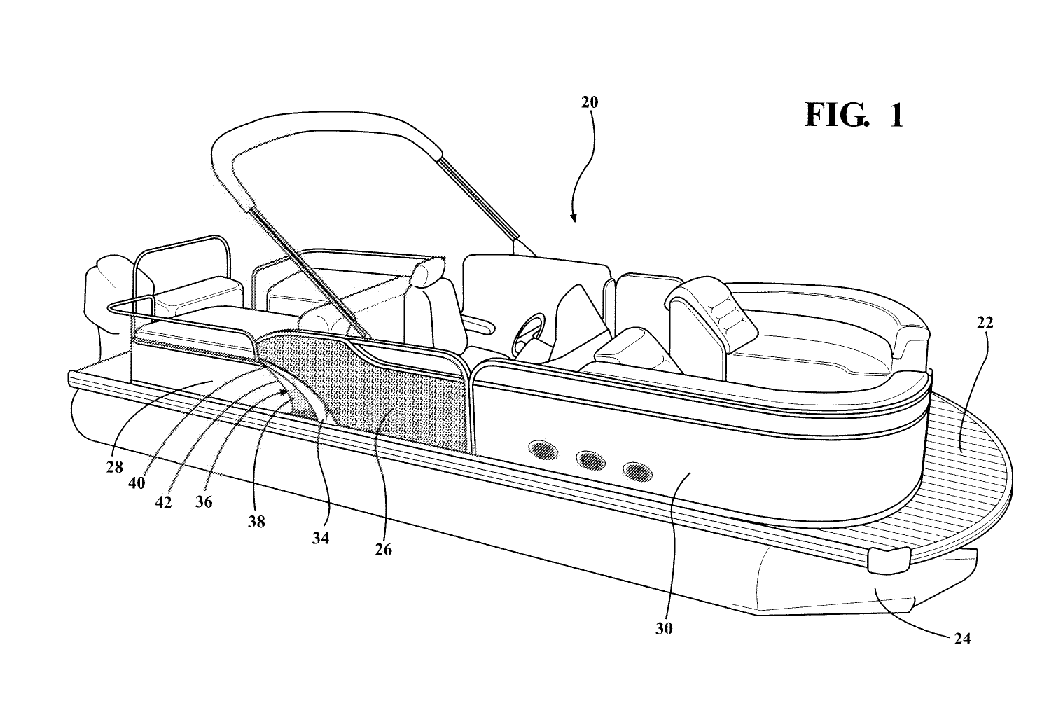

Referring to the Figures, wherein like numerals indicate corresponding parts throughout the several views, an exemplary pontoon boat 20 is generally shown in FIG. 1. The pontoon boat 20 includes a deck 22 secured to a plurality of tubular, hollow floatable pontoons 24 extending in spaced and parallel relationship with one another to support the deck 22 off the water. Specifically, when the pontoon boat 20 is placed in a body of water, the pontoons 24 displace water to floatably support the deck 22 and the rest of the pontoon boat 20. Although the exemplary pontoon boat 20 has two pontoons 24, it should be appreciated that the pontoon boat 20 could include any desirable number of pontoons 24.

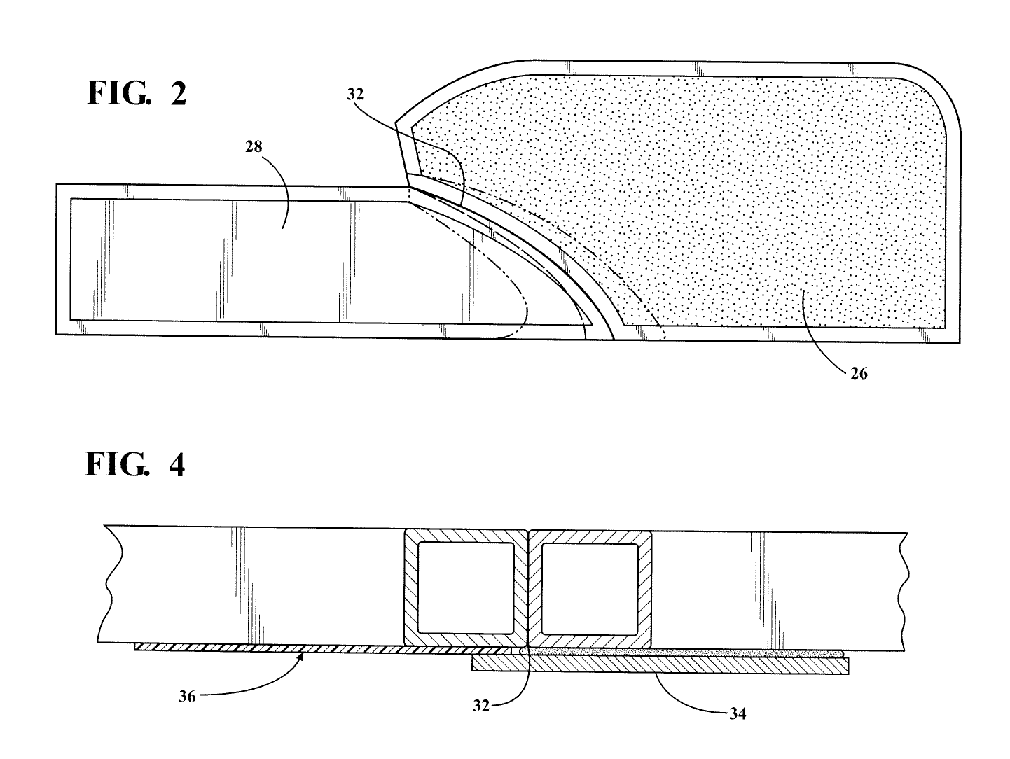

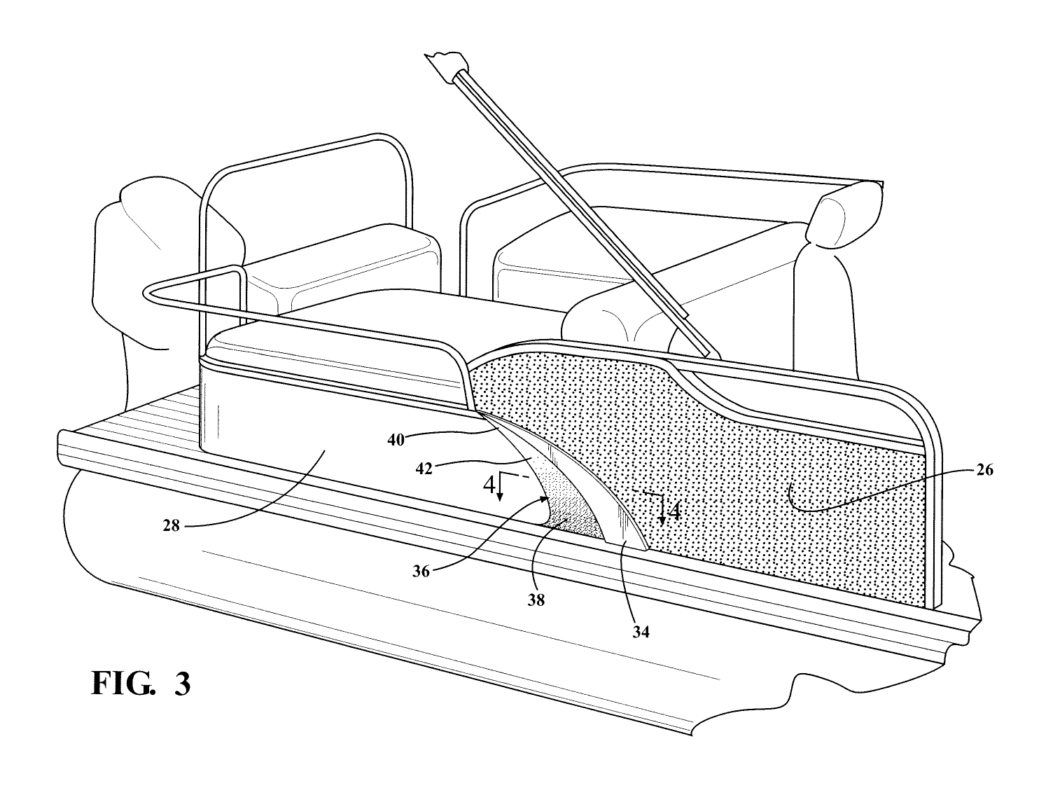

The pontoon boat 20 includes a plurality of wall segments 26, 28, 30 anchored to the deck 22 which collectively define an interior space of the pontoon boat 20 for accommodating passengers. Each of the wall segments 26, 28, 30 extends upwardly to an open end, i.e. not to a roof. One of the wall segments 26, 28, 30 is a first discrete wall segment 26 and another of the wall segments 26, 28 is a second discrete wall segment 28. The first and second wall segments 26, 28 are arranged end-to-end with one another to present a joint 32 therebetween, which is shown in FIG. 2. In the exemplary embodiment, the adjacent ends of the first and second wall segments 26, 28 are curved, and therefore, the joint 32 extends through a curve. However, it should be appreciated that the joint 32 could be straight or could take any desirable shape.

As shown in FIG. 3, a joint cover 34 formed as a separate piece from the first and second wall segments 26, 28 bridges across and substantially conceals the joint 32. The joint cover 34 is preferably secured to the first and second wall segments 26, 28 with an adhesive 36. In the exemplary embodiment, the adhesive 36 is Maxlok™ MX/T18, which is a product of the Lord Corporation. However, it should be appreciated that any other type adhesive may be used instead. Alternately, snaps, bolts or any other fastening means could be used to secure the cover 34 to the wall segments 26, 28 rather than of an adhesive.

In the exemplary embodiment, the joint cover 34 is made of stainless steel for durability, appearance and corrosion-resistance purposes. However, it should be appreciated that the joint cover 34 could be of any material including, for example, other metals, plastic, cardboard, paper, etc. Additionally, the stainless steel joint cover 34 of the exemplary embodiment is polished to present a reflective surface finish. However, it should be appreciated that the cover 34 could have any desirable color or surface finish.

In the exemplary embodiment, the first wall segment 26 has a first color and the second wall segment 28 has a second color different than the first color. Because the joint cover 34 conceals the joint 32 between these wall segments of different colors, it creates the appearance of a one-piece wall having different colors. It should be appreciated that the joint cover 34 could also be used to cover joints between different wall segments having other design attributes.

As shown in FIG. 3, the pontoon boat 20 may also include a transition feature 38 is disposed on one of the wall segments 26, 28 on one side of the cover 34. In the exemplary embodiment, the transition feature 38 is a decal, which has one side shaped similarly to one edge of the cover 34. However, it should be appreciated that the transition feature 38 could take many different shapes and could be of many different materials. The transition feature 38 includes a first color zone 40, a second color zone 42 and a transition zone 44. The transition zone 44 progressively fades from the first color to the second color. This gives the pontoon boat 20 a uniquely luxurious and desirable external appearance by providing a clean transition between the differently colored first and second wall segments 26, 28.

As shown in FIGS. 1 and 2, the first wall segment 26 has a first color and the second wall segment 28 has a second color different than the first color. Thus, the joint 30 between the first and second wall segments 26, 28 represents the intersection of two different wall segments 26, 28 of different colors.

Also included is a method of forming a wall system for a pontoon boat 20. The method starts with the step of mounting first and second wall segments 26, 28 on a deck 22 of a pontoon boat 20 in end-to-end arrangement such that there is a joint 32 between them. Either before or after the first and second wall segments 26, 28 are mounted on the deck 22, the method continues with the step of substantially concealing the joint 32 with a joint cover 34 applied over the joint 32 and extending over a portion of an outer surface of the first and second wall segments 26, 28.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

What is claimed is:

1. A pontoon boat comprising:
a plurality of pontoons;
a deck secured to said pontoons;
a plurality of wall segments anchored to and extending upwardly from said deck to provide an interior space of said deck for accommodating passengers;
said plurality of wall segments including at least a first discrete wall segment having an associated outer panel surface and at least a second discrete wall segment having an associated outer panel surface;
said at least first and second wall segments being arranged end-to-end to present a joint therebetween; and
a joint cover formed as a separate piece from that of said at least first and second wall segments panels, said joint cover bridging across and substantially concealing said joint

2. The pontoon boat as set forth in claim 1 wherein said joint cover is of metal.

3. The pontoon boat as set forth in claim 2 wherein said metal of said joint cover is stainless steel.

4. The pontoon boat as set forth in claim 1 wherein said joint between said first and second wall segments is curved and wherein said joint cover follows said curvature of said joint.

5. The pontoon boat as set forth in claim 1 wherein said first wall segment has a first color and said second wall segment has a second color different than said first color.

6. The pontoon boat as set forth in claim 5 further including a transition feature disposed on one of said first and second wall segments adjacent said joint cover.

7. The pontoon boat as set forth in claim 6 wherein said transition feature has a first color zone and a second color zone and a transition zone between said first and second color zones.

8. The pontoon boat as set forth in claim 7 wherein said first color zone is at the bottom of said transition feature and wherein said first color zone is at the top of said transition feature and wherein transition zone extends between said first and second color zones.

9. The pontoon boat as set forth in claim 1 wherein said joint cover is secured to said first and second wall segments with an adhesive.

10. A method of forming a wall system for a pontoon boat comprising the steps of:
mounting first and second wall segments on a deck of the pontoon boat in end-to-end arrangement such that there is a joint between them; and
either before or after the first and second wall segments are mounted on the deck, substantially concealing the joint with a joint cover applied over the joint and extending over a portion of an outer surface of the first and second wall segments.

11. The method as set forth in claim 10 wherein the joint cover is of metal.

12. The method as set forth in claim 11 wherein the metal of the joint cover is stainless steel.

13. The method as set forth in claim 10 wherein the joint between said first and second wall segments is curved and wherein the joint cover follows the curvature of the joint.

14. The method as set forth in claim 10 further including the step of applying a transition feature to one of the first and second wall segments adjacent the joint cover.

15. The method as set forth in claim 14 wherein the first wall segment is a first color and the second wall segment is a second color different than the first color.

16. The method as set forth in claim 15 wherein the transition feature has a first color zone and a second color zone and a transition zone extending between the first and second color zones.

17. The method as set forth in claim 16 wherein the first color zone is at the bottom of the transition feature and the second color zone is at the top of the transition feature and wherein the transition zone extends between the first and second color zones.
